(19) United States
(12) Patent Application Publication
(10) Pub. No.: US 2010/0230313 A1
(43) Pub. Date: Sep. 16, 2010

(54) PORTABLE TOOL CASE AND WORKSTATION

(75) Inventors: Scott W. ALLAN, Kitchener (CA); Satnam SINGH, Kitchener (CA); Ashwani KAPUR, Waterloo (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: TEAM FAIR HOLDINGS LIMITED, Road Town (VG)

(21) Appl. No.: 12/779,623

(22) Filed: May 13, 2010

Related U.S. Application Data
(62) Division of application No. 11/017,680, filed on Dec. 22, 2004.
(60) Provisional application No. 60/531,984, filed on Dec. 24, 2003.

(51) Int. Cl. B25H 3/02

(52) U.S. Cl. 206/373

(57) ABSTRACT

The invention is directed at a portable tool case and workstation comprising storage means for housing tools; and at least one workstation attachment, stored with the tool case; wherein the at least one workstation attachment cooperates with the tool case to provide a portable workstation to a user.

### CROSS REFERENCE TO RELATED APPLICATIONS

This application is a division of U.S. patent application Ser. No. 11/017,680, filed Dec. 22, 2004, which claims the benefit of U.S. Provisional Application No. 60/531,984, filed Dec. 24, 2003, both of which are incorporated herein by reference in their entirety.

### FIELD OF THE INVENTION

The present invention relates generally to tool cases. More particularly, the present invention relates to a portable tool case and workstation.

### BACKGROUND OF THE INVENTION

Tool cases are well known, and typically include a base, in the form of an open-topped box, and a lid hinged or otherwise mated with the base, with a clip or other means to retain the lid in the closed position. For convenience, these main components will hereinafter be referred to as the base and the lid.

Presently, tool cases are used for the storage of tools, such as a rotary tool, and its various associated accessories. In some cases, use of the tools in the tool case also requires the use of workstation or workbench attachments, such as a vise. Many times, these attachments are located on, or attached to, a workbench which is remote from a job site and location of the tool case. It is therefore quite inconvenient for a handyman to have the workstation attachments situated in one location while the tool case is located elsewhere and vice versa. Also, if the user is using the tools and realizes at a later time that he/she needs access to workstation attachments, the user generally has to carry the tool case or the individually required tools over to the workbench to work with the workstation attachments.

On the other hand, this also causes inconveniences to the user if the tools and workpiece are being worked on at the workbench since it may be a distance away from the job site where it is required. Therefore, if the user is trying to fit the workpiece into a specific location i.e. if it must be a specific size, the user must go back and forth between the workbench and the job site until the workpiece is the correct size.

Prior art tool cases do not offer much flexibility, nor are they very efficient, since it can be very time-consuming and frustrating moving between the job site and the workbench with the required attachments.

It is therefore desirable to provide a portable tool case and workstation which overcomes some of the disadvantages of the prior art.

### SUMMARY OF THE INVENTION

It is an object of the invention to obviate or mitigate at least one disadvantage of previous tool cases.

This invention therefore provides a portable tool case and workstation which allows a user to have access to both tools and workstation attachments at a location proximate a job site.

It is an aspect of the invention to provide a portable workstation with various means to facilitate working with a work piece at a job site. Thus, in one aspect of the invention, a tool case is provided with a workstation attachment, such as a fold-out vise.

Therefore, there is provided in an aspect of the present invention, a portable tool case and workstation comprising storage means for housing tools; at least one workstation attachment, stored with the tool case; wherein the at least one workstation attachment cooperates with the tool case to provide a portable workstation to a user.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1A is a perspective view of a first embodiment of a tool case and workstation in a closed position;

FIG. 1B is a perspective view of the tool case and workstation of FIG. 1A in the open position with a workstation attachment in an operational position;

FIG. 1C is a perspective view of the workstation attachment;

FIG. 1D is a perspective view of the tool case and workstation of FIG. 1A in use;

FIG. 1E is a side view of the tool case and workstation of FIG. 1A in use;

FIG. 1F is a side view of a second embodiment of a workstation attachment;

FIG. 1G is a side view of yet another embodiment of a workstation attachment;

FIG. 1H is a perspective view of the portable tool case and workstation with another embodiment of a workstation attachment;

FIG. 1I is a perspective view of the portable tool case and workstation of FIG. 1H in use;

FIG. 2A is a top view of a second embodiment of a tool case and workstation in an open position with a workstation attachment in a storage position;

FIG. 2B is a rear view, with part of the rear broken away, of the tool case and workstation of FIG. 2A with the workstation attachment in the storage position;

FIG. 2C is a perspective view of the tool case and workstation of FIG. 2A in use with the workstation attachment in an operational position;

FIG. 2D is a rear view of the tool case and workstation with the workstation attachment in the operational position;

FIG. 2E is a perspective view of the tool case and workstation with the workstation attachment in the operational position;

FIG. 2F is a side view of the tool case and workstation with the workstation attachment in the operational position;

FIG. 3A is a perspective view of a third embodiment of a tool case and workstation;

FIG. 3B is a side view of the tool case and workstation of FIG. 3A;

FIG. 4A is a perspective view of a fourth embodiment of a tool case and workstation in a closed position;

FIG. 4B is a bottom perspective view of the tool case and workstation of FIG. 4A in an open position;

FIG. 4C is a perspective view of the tool case and workstation of FIG. 4A in the open position;

FIG. 4D is a bottom perspective view of another embodiment of a portable tool case and workstation;

FIG. 4E is a perspective view of the embodiment of FIG. 4D with legs extended;

FIG. 4F is a perspective view of two portable tool case and workstations connected;

FIG. 5A is a perspective view of a workstation attachment;

FIG. 5B is a front view of the workstation attachment;

FIG. 5C is a side view of the workstation attachment;

FIG. 5D is a top view of the workstation attachment;

FIG. 6A is a perspective view of a rotary tool mounted on the workstation attachment of FIG. 5A;

FIG. 6B is a front view of FIG. 6A; and

FIG. 6C is a side view of FIG. 6A.

### DETAILED DESCRIPTION

Generally, the present invention provides a portable tool case and workstation. The tool case and workstation has at least one workstation attachment, such as a vise, preferably housed within the tool case and workstation, so that a user of the tools does not have to commute between a workbench and the job site in order to use workstation attachments. This allows a user to save time completing a job at a job site since there is less time spent travelling between the job site and a workbench. The tool case and workstation includes storage means to house tools, such as a rotary tool and its accessories.

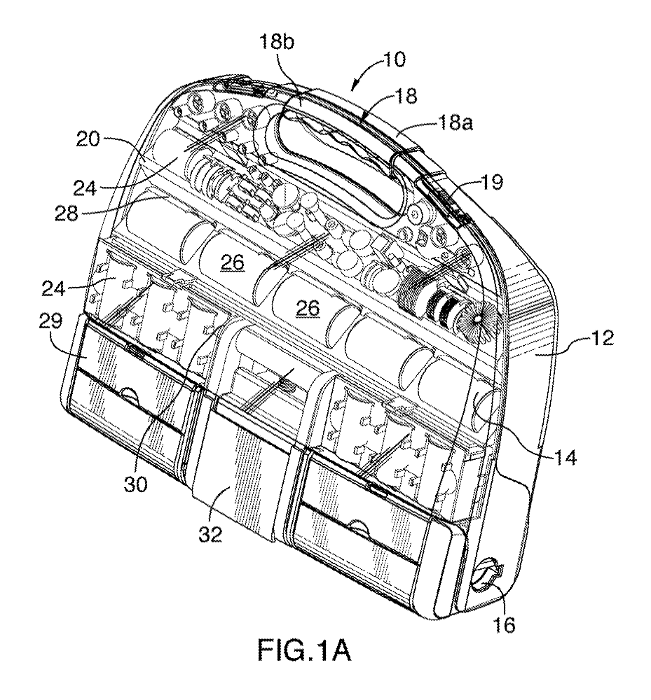

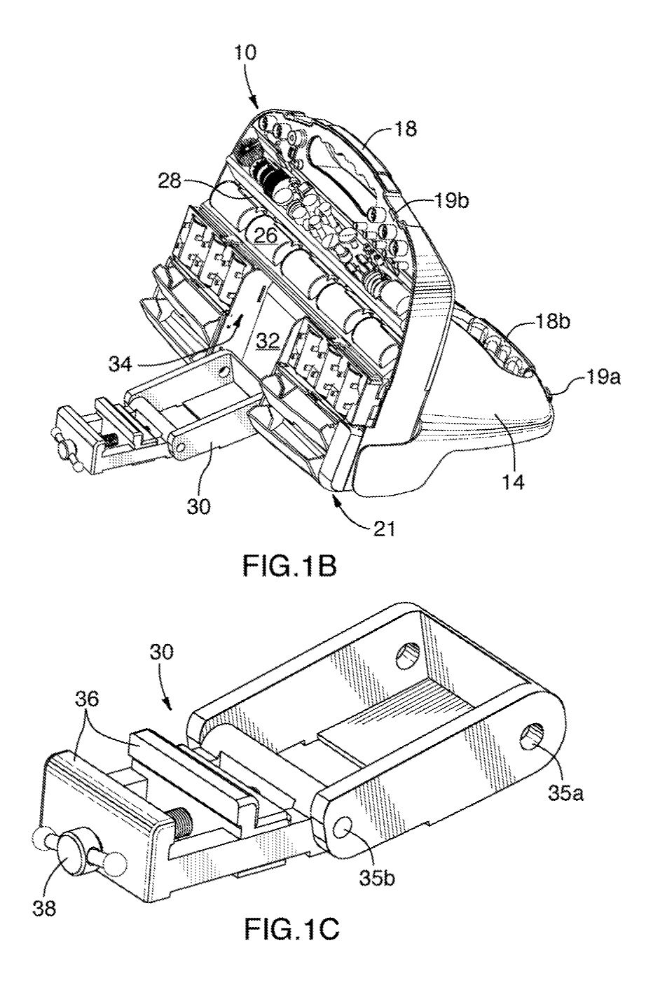

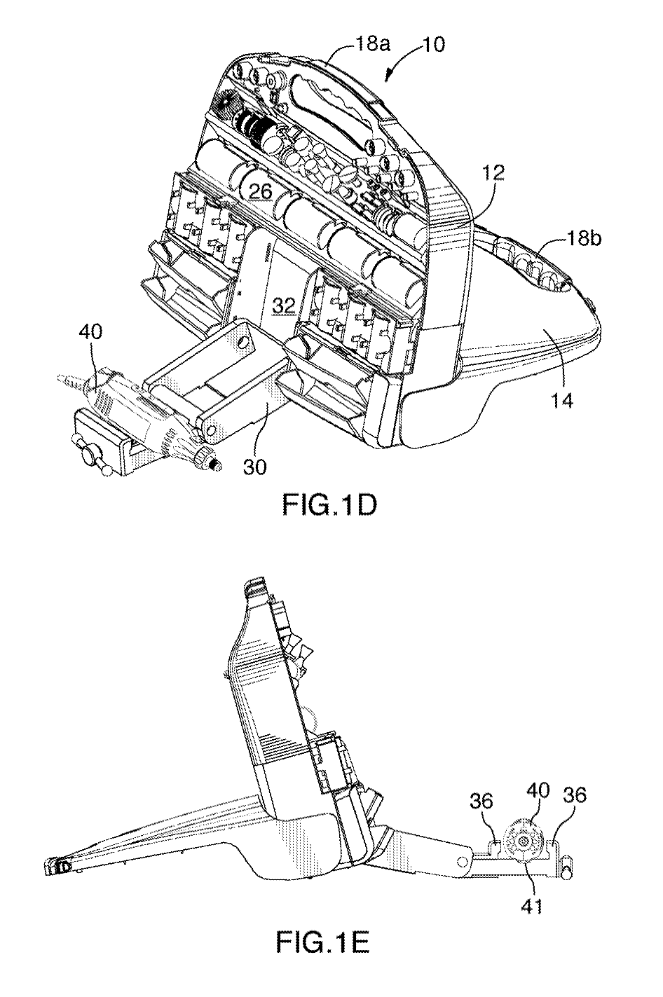

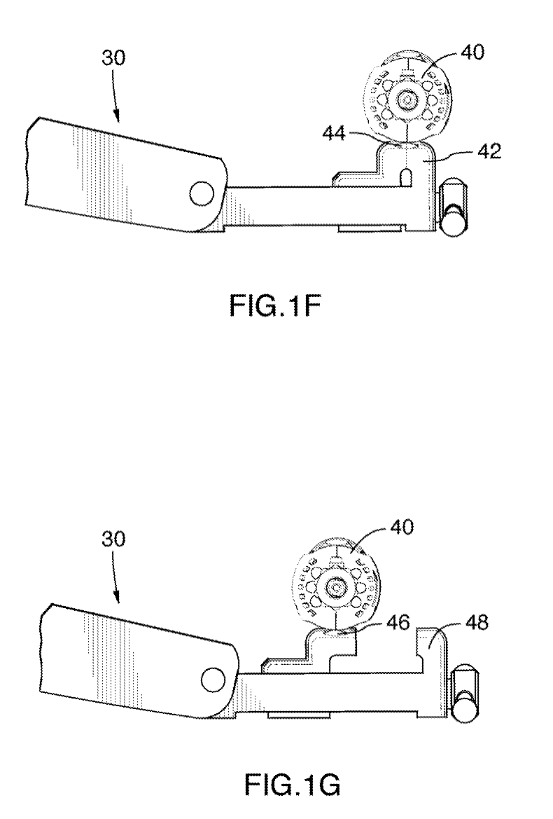

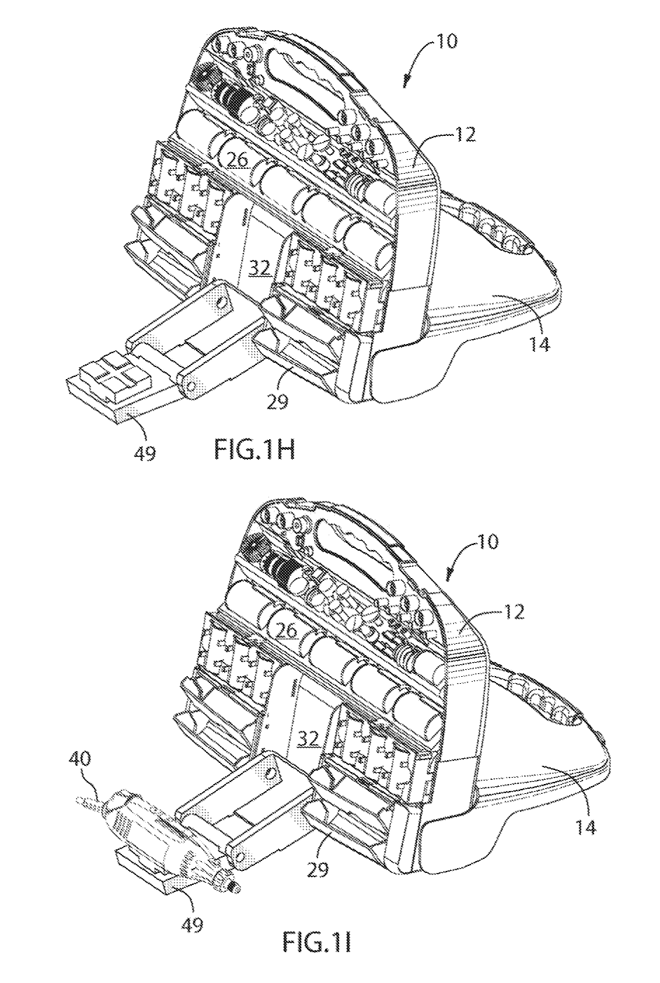

Referring to the drawings, FIG. 1A shows a first embodiment of a tool case and workstation in a closed position. The tool case and workstation 10 has a base portion 12 and a lid portion 14. The lid portion 14 is attached to the base portion 12 by connecting means 16. In the present embodiment, the lid portion 14 is manufactured from a transparent plastic which allows the contents of the tool case and workstation 10 to be seen even when the tool case and workstation is in the closed position. Alternatively, the lid portion 14 may be manufactured from an opaque plastic. The base and lid portions 12 and 14 of the tool case and workstation 10 preferably have handles 18a and 18b, respectively, that complement each other to provide a carrying grip 18 for the user when the tool case and workstation 10 is in the closed position.

Locking means 19 secure the lid portion 14 to the base portion 12 in the closed position so that the tool case and workstation 10 cannot be inadvertently opened. In the present embodiment, the locking means 19 are a pair of slidable tabs 19a on the lid portion 14 which latch onto individual ridges 19b on the base portion 12 as more clearly shown in FIG. 1B. It will be understood that other means to secure the lid portion 12 to the base portion 14 are possible and will be known to one skilled in the art. A combination of various designs and material selection for the lid portion 14, the base portion 12, the handles 18a and 18b, the locking means 19 and the connecting means 16 preferably results in a light weight tool case which allows easier portability without compromising the impact-resistant properties or the toughness of the tool case and workstation.

Within the portable tool case and workstation 10, storage means, such as a plurality of panel sections 20 are located between the base portion 12 and the lid portion 14. The panel sections 20 have a plurality of apertures 22 (hidden by the tool accessories) arranged on its surface to receive tools and/or tool holders and also to provide storage space for the tool accessories. Furthermore, the apertures 22 may be designed to receive interchangeable panels allowing the user to adapt and customize the tool case and workstation 10 for different tool sets. The panel sections 20 preferably include first fastening means (not shown) to cooperate with second fastening means (not shown) arranged on the inside of the base portion 12, to securely hold the panels 20 in place when the tool case and workstation 10 is in the closed position. Attachment of these panel sections 20 to the inside of the base portion 12 is described below but will be well understood by one skilled in the art. By making the panel sections 20 detachable, this allows the storage means of the tool case and workstation to be customized along with allowing items to be stored behind the panel sections 20 between the panel sections and the base portion 12.

In one embodiment, the first fastening means are preferably posts protruding from a bottom or rear surface of the panel section 20 which are then inserted into corresponding second fastening means, located on an internal surface of the base portion 12, in the form of female openings projecting upwardly from the base portion 12. At least one of the panel sections may be detachable from the base portion 12 to allow for additional storage between the panel and the base portion 12. Other fastening means include clips which may be used to enable removal of panel for extra storage beneath.

As shown in FIG. 1B, when the tool case and workstation is placed in the open position, the lid portion 14 is pivotable, about the connecting means, so that it rests behind the base portion 12 to provide a stand for the tool case and workstation 10. This enables the tool case and workstation to be placed on a work surface close to the job site to provide convenient access to the tool and tool accessories and workstation, or workbench, attachment 30, such as one with a dovetail groove, stored within.

In order to prevent slipping or movement of the tool case and workstation 10 while the workstation aspect is in use, securing means, preferably anti-friction, attaching the tool case and workstation 10 to the work surface are employed. These include, but are not limited to, rubber feet, a router mat or suction cups, all providing non-slip characteristics, located on a bottom surface 21 of the tool case and workstation 10 or the surface of the lid portion 14b which contacts the work surface when in the open position. Furthermore, the securing means may be a hold-down clamping device. Other securing means includes screws, magnets or even magnetic plates. Securing means may also be located on the workstation attachment to assist in securing the tool and workstation attachment to the work surface when the workstation is attached and for securing the workstation attachment to the work surface is the workstation attachment has been detached from the tool case and workstation. The securing means on the workstation attachment preferably allow the attachment to be quickly attached and/or released from the workstation.

The tool case and workstation 10 also comprises locations for additional storage capacity 24 in the form of removable storage bins 26. Tabs 28, located atop the bins 26 allow each bin to be kept closed so that its contents do not fall out unexpectedly. When the user wishes to access the contents of the bins 26, the bins may be manually released from its corresponding tab 28. Further storage is provided by storage drawers 29 (or tiltable bins) which, in this embodiment, are located at a bottom of the tool case and workstation 10. The bins 26 and storage drawers 29, are preferably detachable, with the bins being internally accessible and the drawers 29 being externally accessible. It will be understood that the contents may be organized in categories such as sanding accessories, polishing accessories or attachments. This allows for the different content groups to be interchangeable allowing for a more customizable tool case and workstation.

The tool case and workstation 10 also includes at least one workstation attachment 30. When not in use, the workstation attachment 30 is placed into an attachment housing 32 into the storage position, allowing the lid portion 14 to close. It will be understood that in the present embodiment, the workstation attachment 30 is hinged so that it is folded into and out from the attachment housing 32. Alternatively, the workstation attachment 30 may be slid back into the attachment housing 32 or may be connected to the attachment housing using a swivel mechanism or any other known means of attachment.

In the present embodiment, the workstation attachment 30 is a vise, and more specifically, a double-articulating fold-out vise, which folds out in order to provide a user with workstation capabilities without having to return to a workbench when a workstation attachment such as a vise is required. Use of a double articulating vise, allows for a greater space between the working area and the tool case and workstation 10 in order to prevent sparks or dust from contacting the contents.

In this embodiment, the workstation attachment 30 is stored within the attachment housing 32 near the bottom of the tool case and workstation 10 but it will be understood that the workstation attachment may be located elsewhere within tool case and workstation 10. The attachment housing 32 includes a pair of side walls 34 which include means for attaching the workstation attachment 30 to the attachment housing 32. The means for attaching preferably include a hinge mechanism so that the workstation attachment 30 may be easily folded out from and in to the attachment housing 32 when the user requires use of the workstation attachment or wishes to place the workstation attachment in a storage position, respectively. When use of the vise is required, the vise is extended out from the attachment housing 32 to lie flat on a work surface atop which the tool case and workstation 10 rests.

Alternatively, the attachment may be detachable from the means for attaching so that the workstation attachment may be used separate from the tool case and workstation. Although shown with a hinge mechanism, the means for attaching may also be quick release or other conventional means for attaching.

Turning to FIG. 1C, a perspective view of the workstation attachment is shown. The attachment 30, or vise, in the preferred embodiment, comprises a pair of hinges 35 forming a hinge mechanism along with a grip 36. The hinge portion 35a is preferably attached to the connecting means of the attachment housing 32.

The opening of the grip 36 may be altered by the sizer 38 which allows a user to change the size of the space defined by the grip 36 to accommodate the work piece or a tool. Alternatively, the vise could be a quick-locking vise without the need for the sizer.

Turning to FIG. 1D, a perspective view of the tool case and workstation in use is shown. In FIG. 1D, the workstation attachment 30 is used to hold a rotary tool 40 in place such that the rotary tool 40 may then be used as a bench grinder allowing the user to manipulate a work piece with both hands while using the rotary tool (bench grinder). Alternatively, the workstation attachment, or vise in the present embodiment, may be used to grip a workpiece allowing a user to manipulate a tool with both hands to work on the workpiece. As described above, the workstation attachment 30 allows a user to perform regular workbench activities without having to move from their job site. Typically vises are used for clamping but it will be understood that there are many other uses for a vise.

Turning to FIG. 1E, a side view of the tool case and workstation is shown. As shown in FIG. 1E, the rotary tool 40 is held in the grip 36 of the workstation attachment 30. The vise preferably includes a groove 41, such as a dovetail groove, which receives a corresponding groove from the rotary tool 40 in order to further secure the rotary tool to the workstation attachment.

Turning to FIG. 1F, a second embodiment of a workstation attachment 30 is shown. In this embodiment, when a grip 42 of the workstation attachment 30 is closed, the top edge of the grip 42 forms a groove 44, within which a complementary groove on the surface of the rotary tool 40 may be inserted in order to secure the rotary tool 40 in place.

Turning to FIG. 1G, a third embodiment of a workstation attachment 30 is shown. In this embodiment, a groove 46 is formed on the top edge of one of the grips 48 which receives the rotary tool 40 in order to secure the rotary tool 40 in place.

Turning to FIG. 1H, a tool case and workstation is shown with a second type of workstation attachment. In FIG. 1H, the workstation attachment 49 is a universal holder with dovetail grooves. Similar to the vise described above, the workstation attachment 49 may be folded out from a storage position into an operational position so that a user may attach a tool to the workstation attachment 49, as shown in FIG. 1I. In FIG. 1I, an example of the workstation attachment 49 in use is shown with a rotary tool being attached to the universal holder. The rotary tool preferably has complementary dovetail grooves which mate with the dovetail grooves on the universal holder allowing for quick release and attachment of the tool to the workstation attachment. The workstation attachment preferably includes locking means for maintaining the connection between the workstation attachment and the tool.

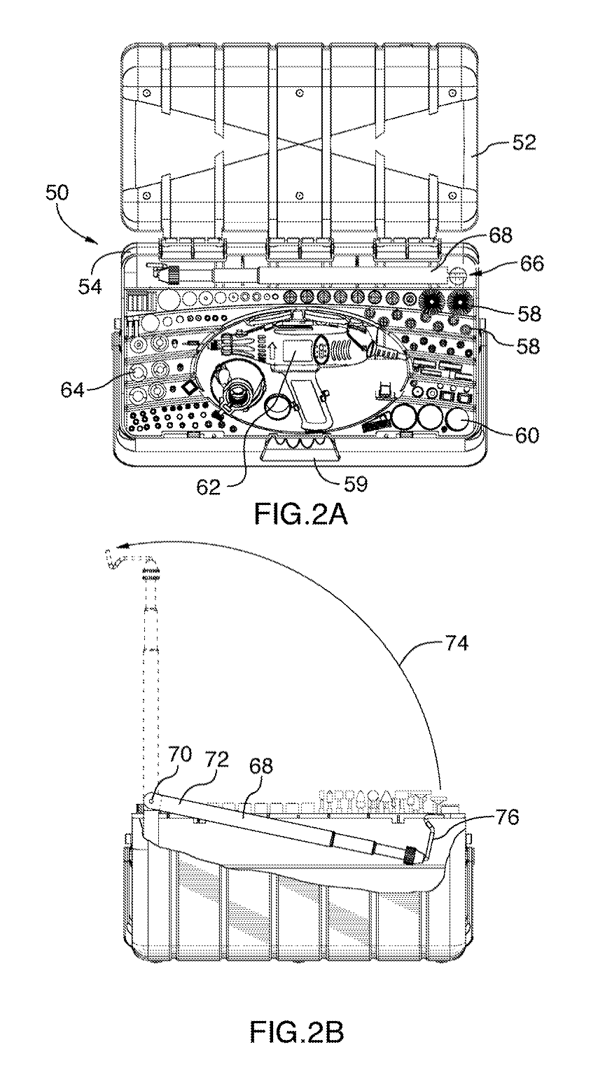

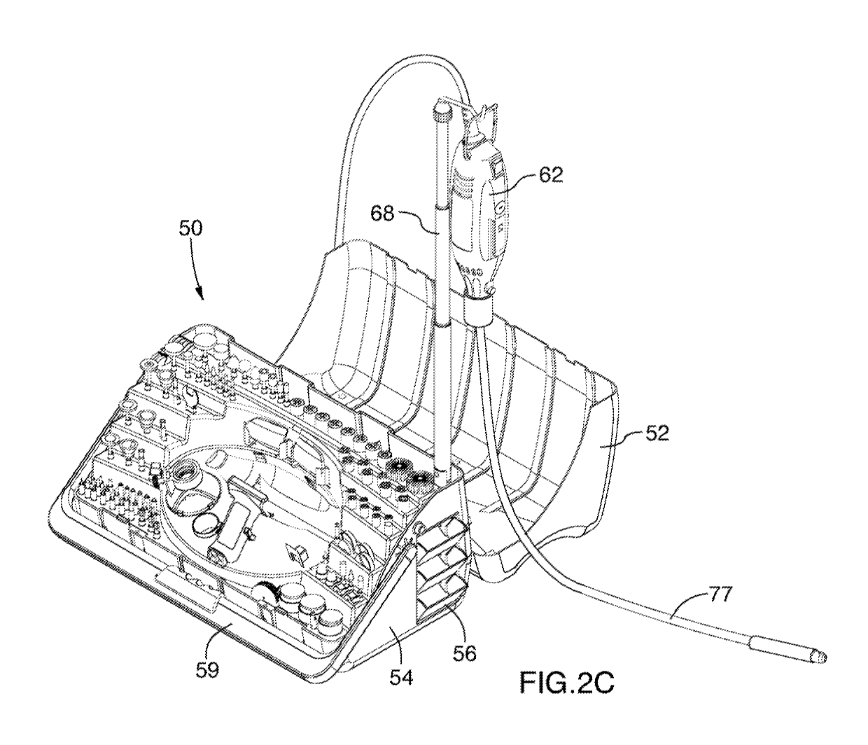

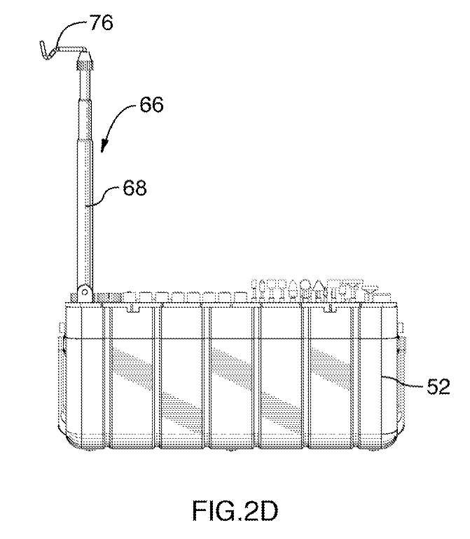

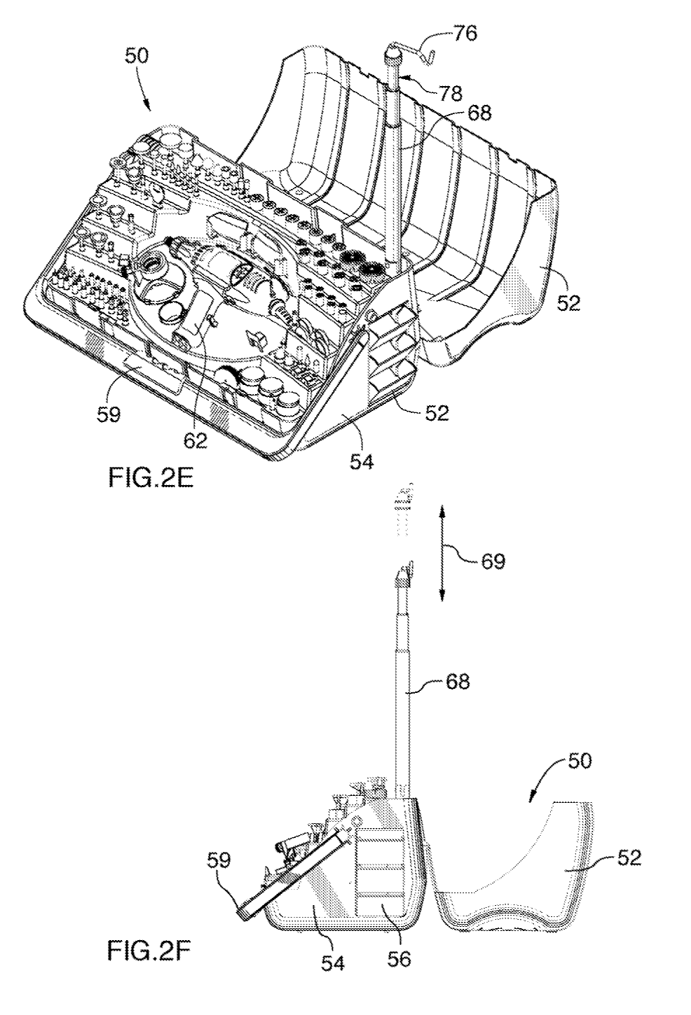

Turning to FIG. 2A, a second embodiment of a tool case and workstation 50 in an open position is shown. The tool case and workstation 50 comprises a lid portion 52 along with a base portion 54. As shown in FIG. 2C, a set of externally accessible storage modules 56, which may be removable, are located at one side of the tool case and workstation 50 to provide further storage area for small tool accessories or hardware parts such as nails or screws. The tool case and workstation 50 also preferably includes a handle 59 for carrying the tool case and workstation 50 from one location to another.

The tool case and workstation 50 provides shelving 58 for the storage of tool components 60 which in the present embodiment are shown as a rotary tool 62 and rotary tool accessories 64.

As shown in FIG. 2A, the tool case and workstation 50 further comprises a workstation attachment 66, which in this embodiment is a tool holder, seen as a pole 68 and hook 76. In the storage position, the workstation attachment 66 is stored between the shelving 58 and the rear of the base portion 54. This may be more clearly seen in FIG. 2B which is a rear view of the tool case and workstation 50 with a portion of the rear wall of the base portion 54 cut away.

The pole 68 is preferably hinged using a hinge mechanism 70 at a bottom end 72 so that when the user wishes to move the pole 68 from the storage position to an operational position, the user is only required grasp the pole 68 and pull it up to the operational position in the direction shown by arrow 74. When the user is finished using the workstation attachment 66, the pole 68 may be returned to the storage position. It will be understood that the hinge portion 70 includes a locking mechanism to keep the pole 68 in place when in the operational position.

The pole 68 also includes the hook 76 at a top end 78 so that the user may rest the rotary tool 60 on the hook 76 when required (as shown in FIG. 2C) or to elevate the rotary tool from the work surface. This also reduces the operating noise level, provides easier access to the workpiece and prevents the rotary tool from moving around on the work surface. The hook 76 may also be used to hold other items in order to allow a user to use both hands to work on the workpiece or to provide easier access to the tool.

In this embodiment, when in use, as shown in FIG. 2C, the rotary tool 62 is hung on the hook 76 and a flex shaft 77 is attached to the rotary tool 62 so that the user may use the rotary tool while having both hands available to control the workpiece which they are working on.

Alternatively, rather than being hinged, the bottom end 72 of the pole 68 may be threaded and therefore when the user wishes to use the pole 68, the user removes the pole from its storage position and attaches the pole to a complementary threaded section preferably located in the storage space between the shelving 58 and the rear of the base portion.

Whether the pole 68 is hingedly attached or threaded to, or otherwise cooperating with the tool case/workstation 50, when in the operational position, the resulting tool case and workstation is shown in FIG. 2C. FIGS. 2E, 2F and 2G provide a rear view, a perspective view and a side view, respectively, of the tool case and workstation 50 in the open position with the workstation attachment 66 in the operational position.

As shown in FIG. 2G, the pole 68 may be telescopic so that the height of the pole 68 may be adjusted according to a height preferred by the user.

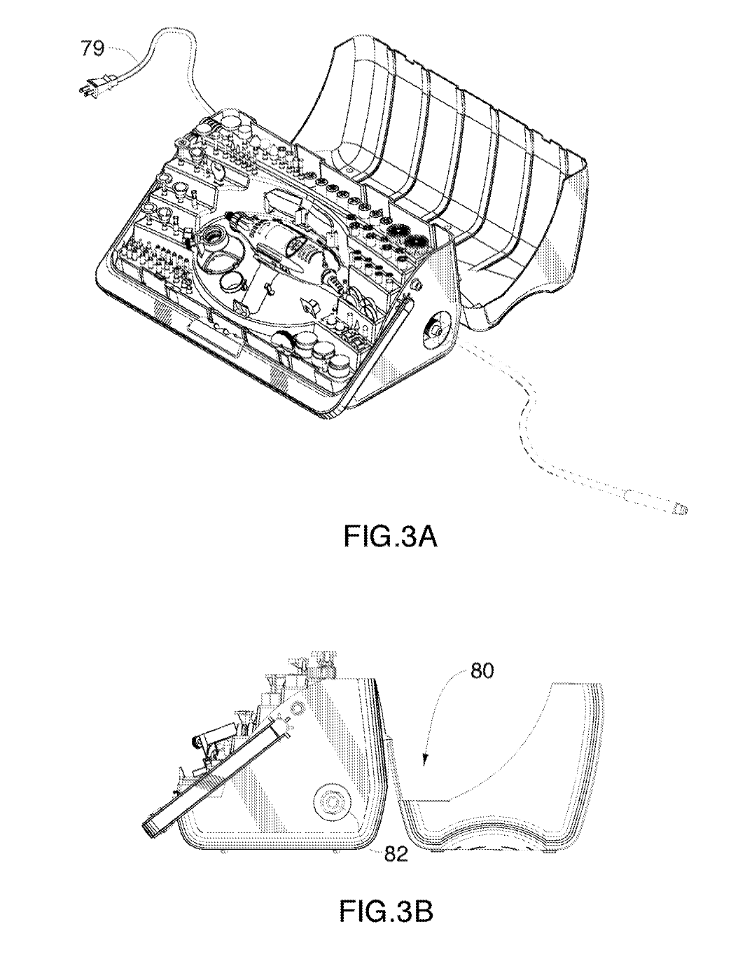

Turning to FIGS. 3A and 3B, a third embodiment of a tool case and workstation 80 is shown. The embodiment is similar to the embodiment of FIGS. 2A with the addition of a workstation attachment, such as a rotary motor 82. It will be understood that the pole may or not be included in this embodiment. As shown in FIG. 3A, a flex shaft 84 may be attached to the rotary motor 82 so that the user may work with a rotary tool while having both hands free to control the workpiece being worked on. Although not shown, the tool case and workstation 80 may also include externally accessible storage modules. The rotary motor 82 allows a user to have the benefit of a flex shaft rotary tool located proximate the job site.

The tool case and workstation 80 may further comprise electrical connectivity means such as a power cord 79 which may be plugged into a power source and at least one electrical socket (not shown) for receiving plugs of power tools such as the rotary tool 81 shown in the tool case and workstation 80.

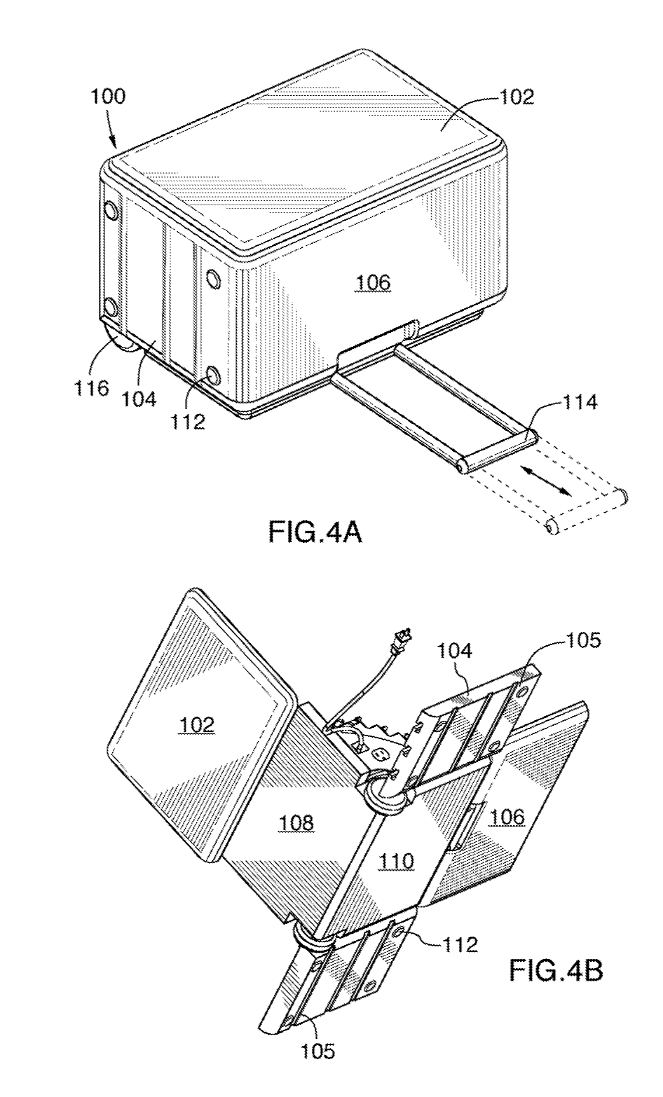

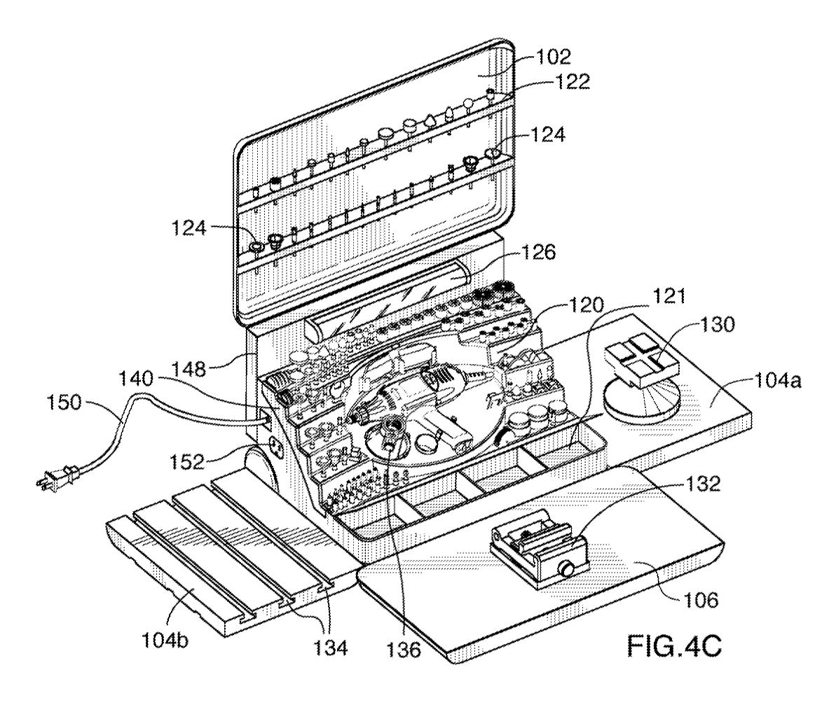

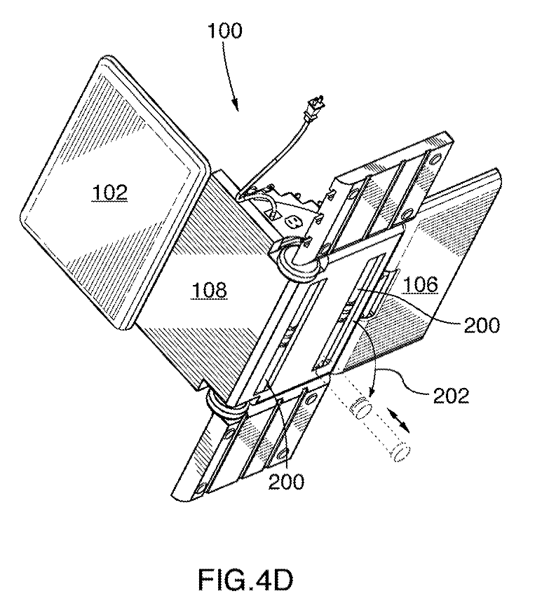

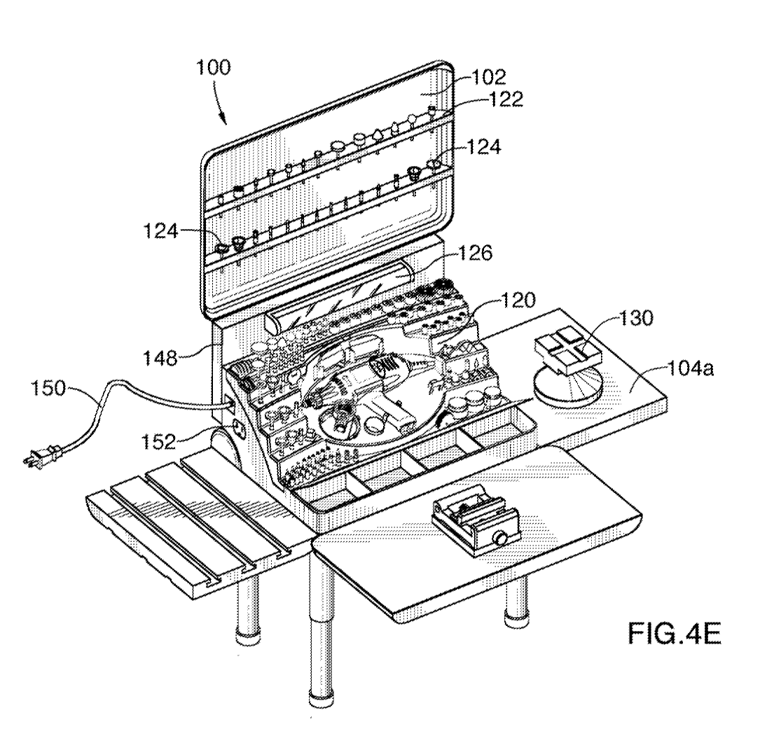

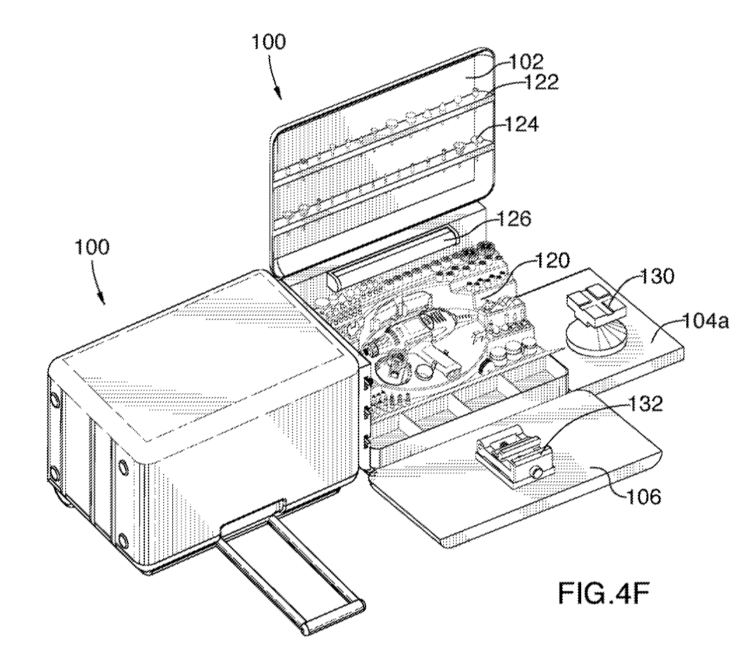

Turning to FIGS. 4A to 4C, a fourth embodiment of a tool case and workstation in accordance with the present invention is shown.

The tool case and workstation 100 comprises a top wall 102, a pair of side walls 104, a front wall 106, a back wall 108 and a bottom wall 110. In the closed position, as shown in FIG. 4A, the walls 102, 104, 106 and 108 are attached together in order to maintain the tool case in the closed position. Securing means 112 are attached to the outside of the side walls 104 so that when the tool case and workstation 100 is in an open position (as shown in FIG. 4B) and placed atop a work surface, the securing means 112 provide a grip against the work surface so that the tool case and workstation 100 does not slip while the workstation attachments are being used to assist in preventing injuries to the user. Various securing means have been previously disclosed.

As shown in FIG. 4A, the tool case 100 also comprises a handle 114 along with a set of wheels 116 which allow the tool case and workstation to be easily portable. The wheels 116 and handle 114 allow the tool case 100 to be transported in a manner similar to carry-on luggage. In the present embodiment, the front wall 106 includes a slight indent 118 which receives the handle 114 for storage when the tool case is in the open position or when the tool case and workstation 100 is not being moved.

FIG. 4B is a bottom perspective of the tool case and workstation 100 in the open position. As can be seen, once the walls 102, 104, 106, 108 and 110 are unattached from each other, the walls 102, 104, 106, 108 and 110 are folded away each other with the securing means 112 contacting the work surface to provide access to the tools, tool accessories and workstation attachments located within the tool case and workstation. The back wall 108 and the bottom wall 110 remain stationary when the tool case and workstation 100 is opened since a shelf 140 which holds the contents 120 is preferably attached to both the bottom and back walls 110 and 108.

As further shown in FIG. 4B, each of the external surfaces of the side walls 104 includes attachment means, such as dovetail grooves 105, which allow the side walls 104 to be attached to the side wall of another tool case and workstation to provider a larger workstation. This is shown in FIG. 4F which shows a pair of tool case and workstations 100 attached side by side. The grooves 105, may also be used to receive complementary grooves from other tools as well.

FIG. 4C is a perspective view of the tool case and workstation in the open position. After the front wall 106, side walls 104 and top wall 102 are folded away, the contents 120 of the tool case and workstation are then accessible by the user. An inside surface of the top wall 100 preferably comprises shelving 122 for storing items which in the present embodiment are rotary tool accessories 124. An inside surface of the back wall 108 preferably includes a mounted light 126, which may be removable, so that when a user is working in a dark environment, the user may still be able to see the contents 120 of the tool case and workstation 100 as well as to see the work piece that the user is working on.

The tool case and workstation 100 further comprises a set of storage bins 121 which may be used to store small hardware pieces. The set of storage bins 121 preferably includes a lid (not shown) which assist in keeping the contents of the bins in place so that they do not unexpectedly fall out. The storage bins 121 allow the tool case and workstation to be more customizable according to the user's preferences.

In the present embodiment, when in the open position, one of the side walls 104a has a workstation attachment 130, such as a universal mount, with a dovetail attachment, installed on an inside surface so that when the side wall 104a is folded out, the workstation attachment 130 may be accessed by the user. Use of the dovetail, or universal holder, workstation attachment is described below. Similarly, the front wall 106 has a second workstation attachment 132, seen as a vise, mounted on an inside surface so that when the tool case and workstation 100 is opened up, the user may have access to the vise as well. Although, in the present embodiment, the other side wall 104b does not have a workstation attachment mounted on an inside surface, the inside surface of the side wall 104b may have attachment means, such as T grooves 134, which receive tools having complementary grooves on their surface). It will be understood that another workstation attachment may be mounted to the inside surface of the side wall 104b to provide further workstation expandability and customization for a larger workstation.

Furthermore, the tool case and workstation 100 includes a retractable power cord 150 and an electrical outlet 152 to provide electrical connectivity to the tool case and workstation 100 so that a user does not require multiple power cords or extension cords to operate the electric tools.

As shown, in this embodiment, the contents 120 include a rotary tool 136 and the corresponding rotary tool accessories 124. It will be understood that the contents 120 may also be other tools such as a hammer, screwdrivers, wrenches, a drill and drill bits, etc.

FIG. 4D shows another embodiment of the tool case and workstation 100. In this embodiment, the bottom wall 110 includes a set of legs 200, stored in the bottom wall 110 which are preferably hinged to the tool case and workstation 100. Once the tool case and workstation has been ported to the required location, the legs 200 may be rotated about a hinge, as shown by arrow 202, to provide legs to the workstation. This is more clearly shown in FIG. 4E. All the other parts the same as the tool case and workstation 100 described above.

By providing legs 200 to the portable tool case and workstation 100, this allows the workstation attachments to be used even when there is no work surface present for the portable tool case and workstation to be placed atop.

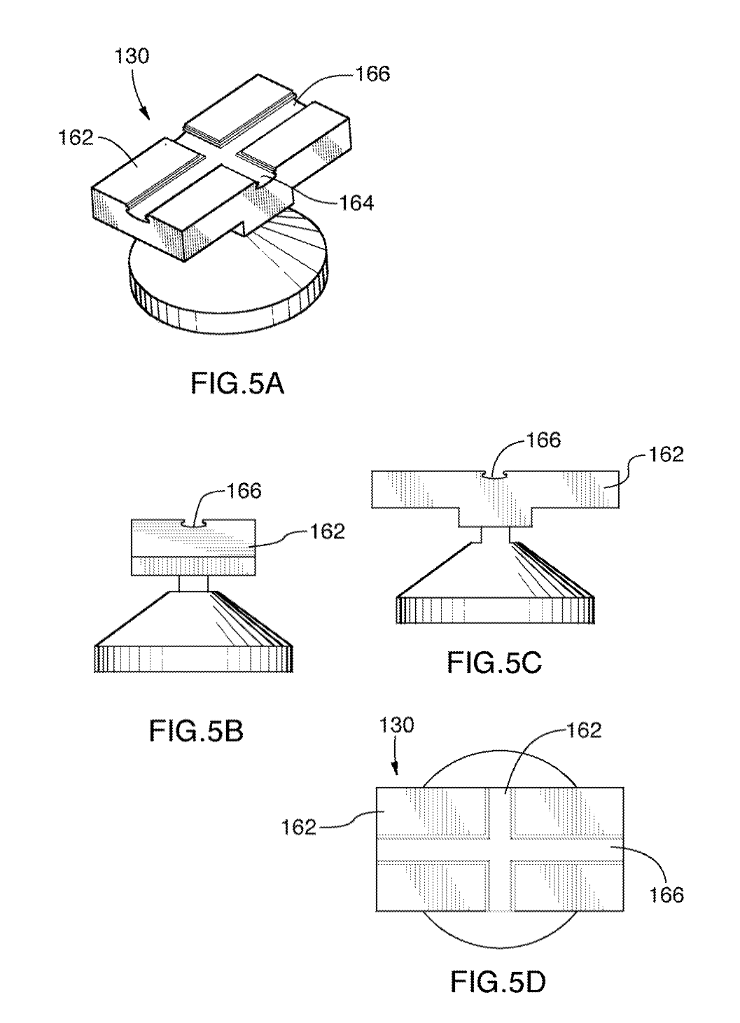

Turning to FIGS. 5A to 5D, a workstation attachment is shown. FIG. 5A provides a perspective view while FIGS. 5B to 5D provide a front view, a side view and a top view, respectively. The workstation attachment 130 of FIGS. 5A to 5D is a universal holder 162 which includes a pair of grooves 164 and 166 to receiving complementary grooves on the surface of tools.

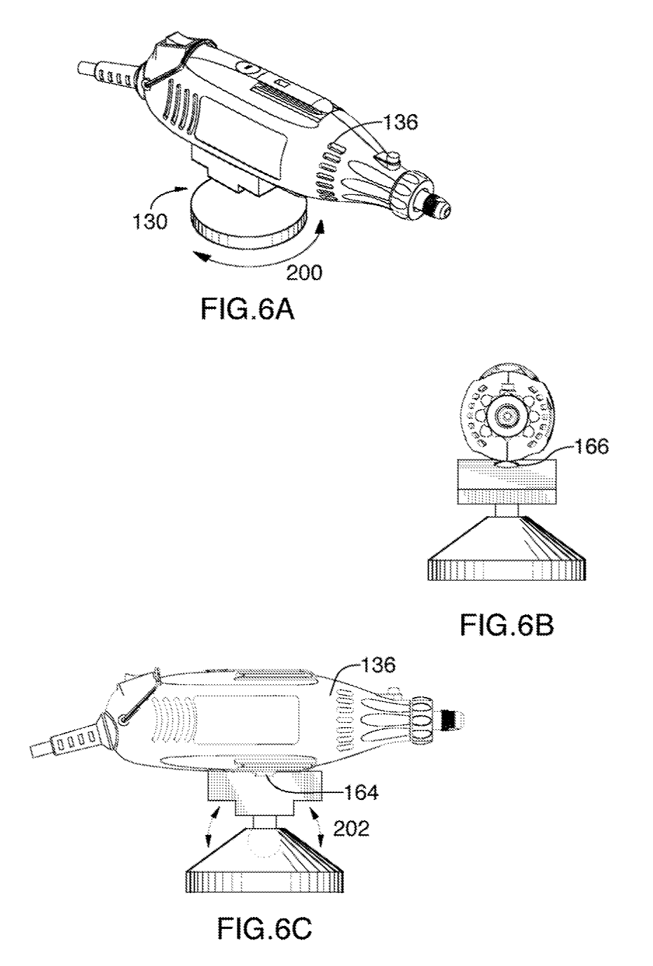

As shown in FIGS. 6A to 6C, a rotary tool having a complementary groove may be easily attached to the workstation attachment of FIG. 5. The workstation attachment may also be rotated as indicated by arrows 200 of FIG. 6A and the height of the workstation attachment may also be adjustable (as indicated by arrows 202 of FIG. 6C). By attaching a tool, such as a rotary tool, to the workstation attachment, this allows a user to have both their hands free to manipulate a workpiece while still being able to use the attached rotary tool.

Furthermore, the tool case and workstation may include mounting means for mounting the tool case and workstation to a table or a wall to provide a sturdy workstation to the user.

When the tool case and workstation stores tools such as rotary tools and their accessories, the tool case and workstation may be advantageously used as a rotary tool workstation which supports such functions as cutting, grinding, sanding, polishing, buffing and/or sawing.

Additional storage space for components and power tools may also be provided at the back of the portable workstation.

In another embodiment of the invention, the workstation attachment may be a work-holding clamping device that is preferably hinged to internal or side walls of the base portion of the tool case and workstation and held securely in folded position by the lid. Alternatively, the hinge can be replaced with a slide mechanism or a swivel mechanism.

The clamping device can be a vise or an articulated holder commonly known as a universal holder or a combination of both.

In another embodiment, the pole may be replaced with stackable extension pieces which serves as a support base.

In a further embodiment, the base portion can be fitted with a drill stand that again, either folds out, slides out, or swivels out and is positioned vertically over a work-surface. The workpiece is located under the device in the desired position and the necessary work performed. After use, the drill stand is the folded and stored in the base portion. The drill stand can also be used to hold the power tool which can be fitted with a router bit. Thus, the device can be lowered onto a work-piece that can be manipulated for the desired results.

The workstation attachment may also be a sharpening guide, and with the use of a swivel clamp, can be made to act as a radial-arm cut-off saw. Engraving or copying attachments can be fitted on the power tool and be held in a pre-determined position while the work-piece is manipulated along X-Y axes.

In yet another aspect, the base portion can be fitted with an extendable arm that can be modified to accept a task-lighting attachment on the distal end.

In another aspect, there can be a fixed fold-out attachment in the workstation that can be combined for use with another attachment, thus adding to the flexibility of the assembly.

In yet another aspect, the base portion can be fitted with an extendable arm that can be modified to receive a magnifying glass for intricate work on smaller work-pieces.

In a further aspect, there are at least two extendable arms that can be located adjacent to each other or be located one in front of the other and adapted for multiple functions.

In yet a further embodiment, for the tool case and workstations which include electrical connectivity, a battery charger may be included so that cordless operation of tool may be provided.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A portable tool case and workstation comprising:
storage means for housing tools; and
at least one tool holder for a tool being operated by a user, stored with the tool case;
wherein the at least one tool holder cooperates with the tool case to provide a portable workstation to a user.

2. The portable tool case and workstation of claim 1 wherein the tool holder is detachable from the tool case and workstation.

3. The portable tool case and workstation of claim 1 wherein the at least one tool holder comprises a pole having a hook attached at a top end.

4. The portable tool case and workstation of claim 1 wherein the tool holder is between shelving of the storage means and a base portion of the tool case.

5. The portable tool case and workstation of claim 3 wherein the pole comprises a hinged portion a bottom end connected to the storage means.

6. The portable tool case and workstation of claim 5 wherein the pole is pivoted from a storage position to an operational position by way of the hinged portion.

7. The portable tool case and workstation of claim 6 wherein the hinged portion further comprises a locking mechanism to keep the pole in the operational position.

8. The portable tool case and workstation of claim 3 wherein the pole is threaded at a bottom end and the storage means comprises a complementary threaded section.

9. The portable tool case and workstation of claim 3 wherein the pole is telescopic.

10. The portable tool case and workstation of claim 3 wherein the hook is designed to receive a rotary tool.

11. The portable tool case and workstation of claim 1 wherein the tool case further comprises a set of externally accessible storage modules.

12. The portable tool case and workstation of claim 1 further comprising a light.

13. The portable tool case and workstation of claim 1 further comprising a handle for carrying said tool case.

14. The portable tool case and workstation of claim 1 further comprising a set of wheels.

15. The portable tool case and workstation of claim 1 further comprising attachment means on an outer surface of said tool case and workstation.

16. A portable tool case and workstation comprising:
a storage area and shelving for housing tools;
a pole, attached to the storage area by way of a hinge mechanism, the pole being pivotable from a storage position to an operational position; and
a hook designed to receive a tool, the hook attached to a top end of the pole;
wherein the pole and the hook cooperate with the tool case to provide a portable workstation to a user.

17. The portable tool case and workstation of claim 16 wherein the pole is telescopic.

18. The portable tool case and workstation of claim 16 wherein the pole is detachable from the storage area of the tool case.

19. The portable tool case and workstation of claim 16 wherein the hinge mechanism further comprises a locking mechanism to retain the pole in the operational position.

20. The portable tool case and workstation of claim 16 wherein the storage position of the pole is between the shelving and a rear portion of the tool case.
